(19) United States
(12) Patent Application Publication
(10) Pub. No.: US 2025/0272033 A1
(43) Pub. Date: Aug. 28, 2025

(54) RELAY DEVICE, COMMUNICATION CONTROL METHOD, AND COMMUNICATION CONTROL SYSTEM

(71) Applicant: SEIKO EPSON CORPORATION, Tokyo (JP)

(72) Inventors: Hironori UTO, SHIOJIRI-SHI (JP); Kenji NARIAI, SHIOJIRI-SHI (JP); Atsuya KONARI, MATSUMOTO-SHI (JP); Toshiaki KOIKE, SHIOJIRI-SHI (JP)

(21) Appl. No.: 19/061,011

(22) Filed: Feb. 24, 2025

(30) Foreign Application Priority Data
Feb. 26, 2024 (JP) 2024-026903

(51) Int. Cl. G06F 3/12

(52) U.S. Cl. CPC G06F 3/1236; G06F 3/1204; G06F 3/126

(57) ABSTRACT

A hub 2 relays communication between a personal computer 1 and a printer 5, and has a control section 21. The control section 21 is configured to perform first control CT1 that performs a first process TR1 on data JC received from the personal computer 1 and transmits data obtained by the first process TR1 to the printer 5, and a second control CT2 that does not perform the first process TR1 on the data JC received from the personal computer 1 and transmits the data JC to the printer 5, and the control section 21 performs either the first control CT1 or the second control CT2.

The present application is based on, and claims priority from JP Application Serial Number 2024-026903, filed Feb. 26, 2024, the disclosure of which is hereby incorporated by reference herein in its entirety.

### BACKGROUND

### 1. Technical Field

The present disclosure relates to a relay device, a communication control method, and a communication control system.

### 2. Related Art

JP-A-2020-123129 discloses a technique in which, even when a communication failure occurs between a host device and a relay device after data transmission from the host device to the relay device is completed, the host device can determine whether the relay device has completed data transmission to peripheral devices.

However, in the relay device (for example, a hub) described in JP-A-2020-123129, there has been a demand for improvements that would satisfy the requirement of being able to directly control a printer connected to the hub from the host side, and the requirement of being able to use the devices connected to the hub with simple control that is not dependent on the device.

### SUMMARY

In order to overcome the above concern, one aspect of a relay device is a relay device that relays communication between an information process device and a printing device, the relay device includes a control section, wherein the control section is configured to perform a first control that performs a first process on data received from the information process device and transmits data obtained by the first process to the printing device, and a second control that does not perform the first process on data received from the information process device and transmits the data to the printing device, and performs either the first control or the second control.

In order to overcome the above concern, one aspect of a communication control method is a communication control method for the relay device that relays communication between an information process device and a printing device, the communication control method includes performing a first control that performs a first process on data received from the information process device and transmits data obtained by the first process to the printing device, and a second control that transmits the data to the printing device without performing the first process on the data received from the information process device and performing either the first control or the second control.

In order to overcome the above concern, one aspect of a communication control system includes an information process device; a printing device; and a relay device that relays communication between the information process device and the printing device, wherein the relay device has a control section, wherein the control section is configured to perform a first control that performs a first process on data received from the information process device and transmits data obtained by the first process to the printing device, and a second control that does not perform the first process on data received from the information process device and transmits the data to the printing device, and performs either the first control or the second control.

### BRIEF DESCRIPTION OF THE DRAWINGS

FIG. 1 is a diagram showing an example of a configuration of a communication control system according to the present embodiment.

FIG. 2 is a diagram showing an example of a configuration of a control section of a hub according to the present embodiment.

FIG. 3 is a flowchart showing an example of a process of the control section of the hub.

### DESCRIPTION OF EMBODIMENTS

Hereinafter, an embodiment will be described with reference to the drawings.

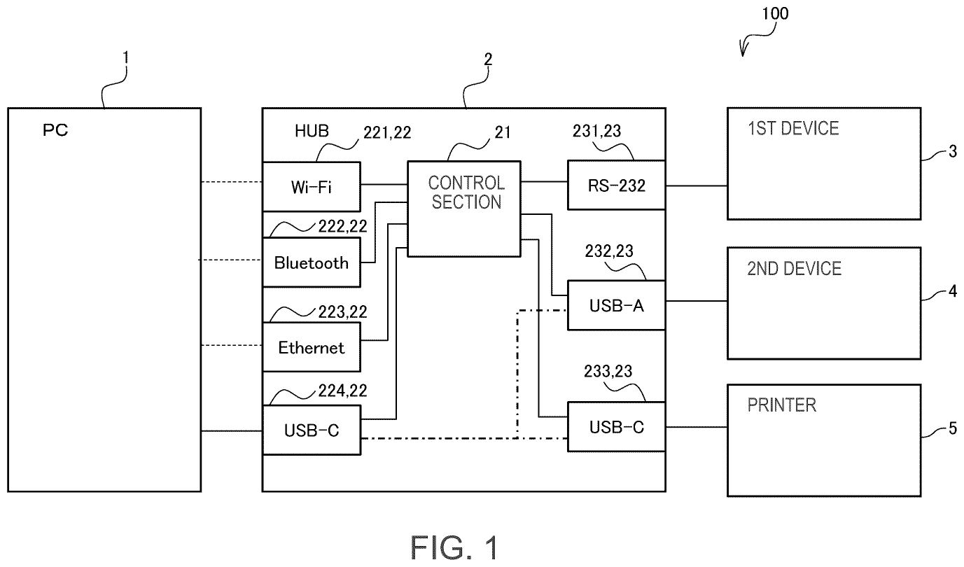

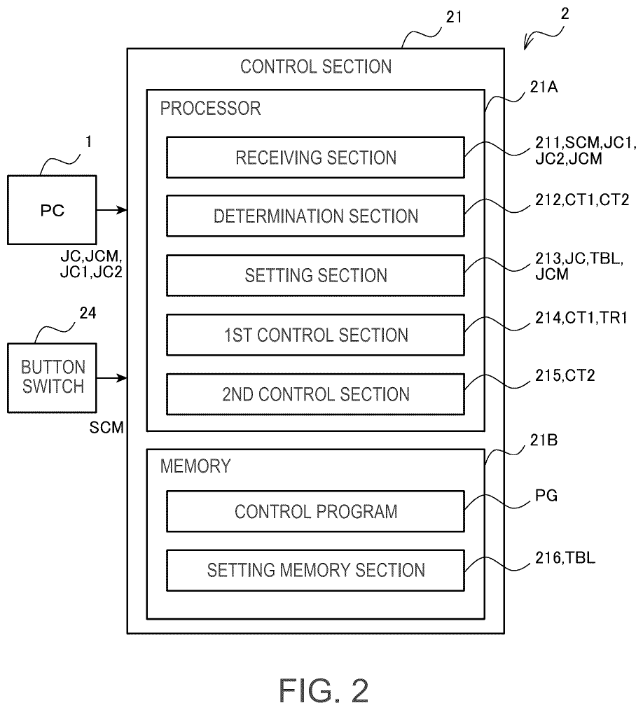

FIG. 1 is a diagram showing an example of a configuration of a communication control system 100. FIG. 2 is a diagram showing an example of a configuration of a control section 21 of a hub 2 according to the present embodiment. As shown in FIG. 1, the communication control system 100 is equipped with a personal computer 1, a hub 2, a first device 3, a second device 4, and a printer 5.

The personal computer 1 outputs instruction information to each of the first device 3, the second device 4, and the printer 5 via the hub 2. The personal computer 1 is installed with an operating system (OS), such as Windows (registered trademark) or Mac OS (registered trademark). The personal computer 1 is configured to be able to communicate with the hub 2 in accordance with each of the Wi-Fi (registered trademark) standard, the Bluetooth (registered trademark) standard, the Ethernet (registered trademark) standard, and the universal serial bus (USB (registered trademark)). The personal computer 1 corresponds to an example of an “information process device.”

The hub 2 relays communication between the personal computer 1 and the printer 5. The hub 2 also relays communication between the personal computer 1 and the first device 3. The hub 2 also relays communication between the personal computer 1 and the second device 4. The hub 2 is equipped with a control section 21, input-side communication interfaces 22, and output-side communication interfaces 23. The hub 2 corresponds to an example of a “relay device.”

As shown in FIG. 2, the control section 21 is equipped with a processor 21A such as a central processing unit (CPU), a memory device 21B such as a read only memory (ROM), a random access memory (RAM), and other peripheral circuits, and controls each section of the hub 2. The memory device 21B is equipped with an electrically erasable programmable read-only memory (EEPROM). The memory device 21B stores a control program PG. The EEPROM of the memory device 21B corresponds to an example of a “setting memory device.”

The processor 21A may be composed of a single processor or may be composed of multiple processors functioning as the processor 21A.

The function of the control section 21 may be realized by one or more processors, or by a semiconductor chip. The control section 21 may be further equipped with a co-processor such as a system-on-a-chip (SOC), micro control unit (MCU), field-programmable gate array (FPGA). The control section 21 may perform various kinds of control by causing both the CPU and the co-processor to cooperate with each other, or by selectively using one of the CPU and the co-processor.

The input-side communication interfaces 22 are communication interfaces that communicate with the personal computer 1. The input-side communication interfaces 22 have a first communication interface 221, a second communication interface 222, a third communication interface 223, and a fourth communication interface 224. In this embodiment, the personal computer 1 is connected to, for example, the fourth communication interface 224.

The first communication interface 221 communicates with the personal computer 1 according to an instruction of the control section 21, for example, according to the Wi-Fi (registered trademark) standard. The first communication interface 221 is equipped with an antenna that transmits and receives Wi-Fi (registered trademark) signals, and an interface circuit that processes Wi-Fi (registered trademark) signals. The first communication interface 221 is an interface substrate having an interface circuit, and is connected to the main substrate on which the processor 21A and the like of the control section 21 are mounted. The interface circuit constituting the first communication interface 221 may be mounted on the main substrate of the control section 21.

The second communication interface 222 communicates with the personal computer 1 according to an instruction of the control section 21, for example, according to the Bluetooth (registered trademark) standard. The second communication interface 222 is equipped with an antenna that transmits and receives Bluetooth (registered trademark) signals and an interface circuit that processes Bluetooth (registered trademark) signals. The second communication interface 222 is an interface substrate having an interface circuit, and is connected to the main substrate on which the processor 21A and the like of the control section 21 are mounted. The interface circuit constituting the second communication interface 222 may be mounted on the main substrate of the control section 21.

The third communication interface 223 communicates with the personal computer 1 according to an instruction of the control section 21, for example, in accordance with the Ethernet (registered trademark) standard. The third communication interface 223 is equipped with a connector that transmits and receives Ethernet (registered trademark) signals and an interface circuit that processes Ethernet (registered trademark) signals. The third communication interface 223 is an interface substrate having an interface circuit, and is connected to the main substrate on which the processor 21A and the like of the control section 21 are mounted. The interface circuit constituting the third communication interface 223 may be mounted on the main substrate of the control section 21.

The fourth communication interface 224 communicates with the personal computer 1 according to an instruction of the control section 21, for example, in accordance with the USB (registered trademark) standard. The fourth communication interface 224 is equipped with a connector that transmits and receives USB (registered trademark) signals and an interface circuit that processes USB (registered trademark) signals. The connector is, for example, a so-called USB (registered trademark) type C connector. The fourth communication interface 224 is an interface substrate having an interface circuit, and is connected to the main substrate on which the processor 21A and the like of the control section 21 are mounted. The interface circuit constituting the fourth communication interface 224 may be mounted on the main substrate of the control section 21.

The connector of the fourth communication interface 224 is communicably connected to a connector of a sixth communication interface 232 and a connector of a seventh communication interface 233 as shown by dotted line in FIG. 1. As will be described with reference to FIG. 2, when the control section 21 performs a second control CT2, the following process is performed. In other words, information input from the personal computer 1 to the connector of the fourth communication interface 224 is output from the connector of the sixth communication interface 232 or the connector of the seventh communication interface 233 in accordance with an instruction of the control section 21.

The output-side communication interfaces 23 are communication interfaces that communicate with the first device 3, the second device 4, and the printer 5. The output-side communication interfaces 23 have a fifth communication interface 231, the sixth communication interface 232, and the seventh communication interface 233. The output-side communication interface 23 is equipped with a plurality of sixth communication interfaces 232. The output-side communication interfaces 23 are equipped with, for example, six sixth communication interfaces 232.

The fifth communication interface 231 communicates with the first device 3 according to an instruction of the control section 21, for example, in accordance with the RS-232 (registered trademark) standard. The fifth communication interface 231 is equipped with a connector that transmits and receives RS-232 (registered trademark) signals, and an interface circuit that processes RS-232 (registered trademark) signals. The fifth communication interface 231 is an interface substrate having an interface circuit, and is connected to the main substrate on which the processor 21A and the like of the control section 21 are mounted. The interface circuit constituting the fifth communication interface 231 is mounted on the main substrate of the control section 21.

The sixth communication interface 232 communicates with the second device 4 according to an instruction of the control section 21, for example, in accordance with the USB (registered trademark) standard. The sixth communication interface 232 is equipped with a connector that transmits receives USB (registered trademark) signals and an interface circuit that processes USB (registered trademark) signals. The connector is, for example, a so-called USB (registered trademark) type A connector. The sixth communication interface 232 is an interface substrate having an interface circuit, and is connected to the main substrate on which the processor 21A and the like of the control section 21 are mounted. The interface circuit constituting the sixth communication interface 232 is mounted on the main substrate of the control section 21.

The seventh communication interface 233 communicates with the printer 5 according to an instruction of the control section 21 in accordance with, for example, the USB (registered trademark) standard. The seventh communication interface 233 is equipped with a connector that transmits and receives USB (registered trademark) signals and an interface circuit that processes USB (registered trademark) signals. The connector is, for example, a so-called USB (registered trademark) type C connector. The seventh communication interface 233 is an interface substrate having an interface circuit, and is connected to the main substrate on which the processor 21A and the like of the control section 21 are mounted. The interface circuit constituting the seventh communication interface 233 is mounted on the main substrate of the control section 21.

The first device 3, the second device 4, and printer 5 are installed in a store such as a supermarket. The first device 3, the second device 4, and printer 5 constitute a part of a point of sale (POS) system, for example.

The first device 3 is, for example, a payment device. The payment device includes an electronic payment device that performs electronic payment and a cash payment device that performs a payment process with cash such as bank bills and coins. The cash payment device includes a change machine. The first device 3 corresponds to an example of a “change machine.”

The second device 4 is, for example, a scanner, a keyboard, or a cash drawer. The second device 4 may be, for example, the payment device. The second device 4 may be, for example, an IC card reader or a magnetic card reader.

The printer 5 is, for example, a thermal printer. The printer 5 prints an image on thermal paper and outputs a receipt, for example. Windows (registered trademark) is installed as the operating system on the printer 5, for example. The printer 5 corresponds to an example of a “printing device.”

The printer 5 includes a “dedicated printer.” The “dedicated printer” is a printer that is configured on the premise that it will be connected to the hub 2 in the present embodiment. In other words, the “dedicated printer” is configured on the premise that the hub 2 can perform first control CT1.

Next, the configuration of the control section 21 of the hub 2 will be described with reference to FIG. 2. FIG. 2 is a diagram showing an example of a configuration of the control section 21 of the hub 2 according to the present embodiment. As shown in FIG. 2, the hub 2 is equipped with a button switch 24.

The button switch 24 is disposed, for example, on an upper surface, a front surface, a rear surface, or a side surface of the housing of the hub 2. The button switch 24 receives an operation that selects either the first control CT1 or the second control CT2 by the user. When the button switch 24 receives an operation by the user, the button switch 24 outputs an operation signal SCM that selects either the first control CT1 or the second control CT2 to the control section 21. The first control CT1 and the second control CT2 will be described below with reference to FIG. 2. The button switch 24 corresponds to an example of an “operation receiving mechanism.”

The control section 21 is equipped with a reception section 211, a determination section 212, a setting section 213, a first control section 214, a second control section 215, and a setting memory section 216. Specifically, by performing the control program PG stored in the memory device 21B, the processor 21A of the control section 21 functions as the reception section 211, the determination section 212, the setting section 213, the first control section 214, and the second control section 215. The processor 21A of the control section 21 causes, by performing the control program PG stored in the memory device 21B, the EEPROM of the memory device 21B to function as the setting memory section 216.

The setting memory section 216 stores in advance a table TBL that associates the first control CT1 or the second control CT2 with the data JC received from the personal computer 1. The table TBL is read out by the setting section 213.

The reception section 211 receives from the button switch 24 an operation signal SCM that selects either the first control CT1 or the second control CT2. The reception section 211 receives from the personal computer 1 first instruction information JC1 for selecting the first control CT1 or second instruction information JC2 for selecting the second control CT2. The reception section 211 also receives command data JCM for the printer 5 from the personal computer 1. The command data JCM corresponds to a command CM that instructs the printer 5.

The determination section 212 determines whether to select the first control CT1 or the second control CT2. For example, when the reception section 211 receives an operation signal SCM, the determination section 212 determines whether to select the first control CT1 or the second control CT2 based on the operation signal SCM.

For example, when the reception section 211 receives the first instruction information JC1 from the personal computer 1, the determination section 212 determines to select the first control CT1. For example, when the reception section 211 receives the second instruction information JC2 from the personal computer 1, the determination section 212 determines to select the second control CT2.

For example, when the personal computer 1 operates on Windows (registered trademark), the determination section 212 determines to select the first control CT1. For example, when the personal computer 1 operates on Mac OS (registered trademark), the determination section 212 determines to select the second control CT2. Windows (registered trademark) corresponds an example of a “first operating system.” Mac OS (registered trademark) corresponds to an example of a “second operating system.”

The determination section 212, for example, when the printer 5 is a “dedicated printer,” determines to select the first control CT1. For example, when data JC for the first device 3 is received from the personal computer 1, the determination section 212 determines to select the first control CT1.

The setting section 213 selects the first control CT1 or the second control CT2 based on the data JC received from the personal computer 1 and the table TBL stored in the setting memory section 216. For example, if the data JC received from personal computer 1 is in extensible markup language (XML) format or in text format, and is command data JCM to the printer 5, the setting section 213 selects the first control CT1. In this case, the first control section 214 performs a process of converting the command data JCM into the command CM as a first process TR1.

The first control section 214 performs the first control CT1 on the data JC received from the personal computer 1. The first control section 214, for example, performs the first process TR1 on the data JC received from the personal computer 1, and transmits the data obtained by the first process TR1 to the printer 5. The first control section 214, for example, performs the first process TR1 on the data JC received from the personal computer 1, and transmits the data obtained by the first process TR1 to the second device 4. The first control section 214, for example, performs the first process TR1 on the data JC received from the personal computer 1, and transmits the data obtained by the first process TR1 to the first device 3.

The second control section 215 performs the second control CT2 on the data JC received from the personal computer 1. For example, without performing the first process TR1 on the data JC received from the personal computer 1, the second control section 215 transmits the received data JC to the printer 5. For example, without performing the first process TR1 on the data JC received from the personal computer 1, the second control section 215 transmits the received data JC to the second device 4.

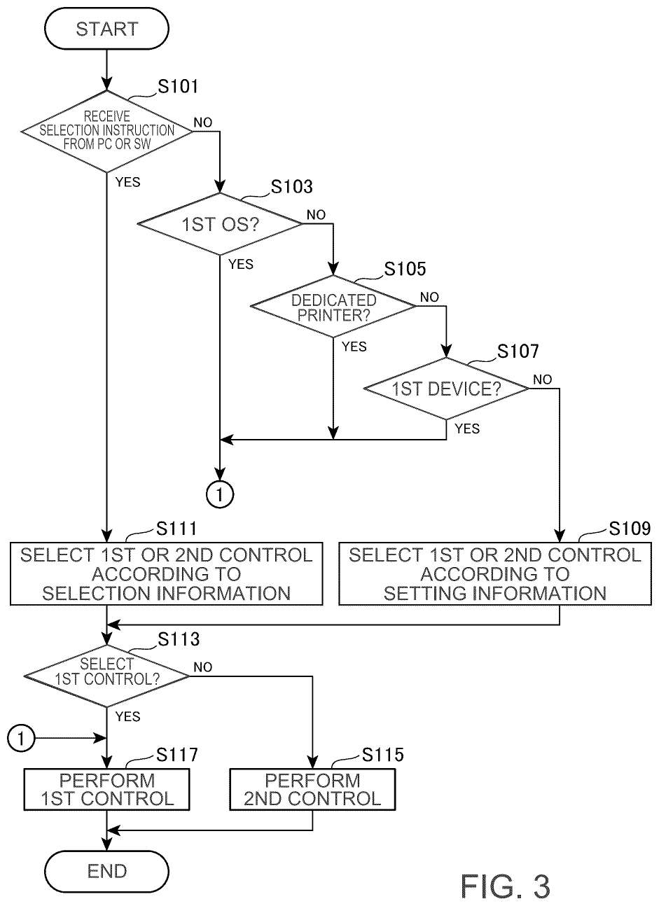

Next, the process of the control section 21 of the hub 2 will be described with reference to FIG. 3. FIG. 3 is a flowchart showing an example of a process of the control section 21 of the hub 2. First, in step S101, the reception section 211 determines whether a selection instruction has been received from the personal computer 1 or the button switch 24. A selection instruction from the personal computer 1 corresponds to the first instruction information JC1 and the second instruction information JC2. A selection instruction from the button switch 24 corresponds to the operation signal SCM. If the reception section 211 determines that the selection instruction is received from the personal computer 1 or the button switch 24 (step S101; YES), the process proceeds to step S111. If the reception section 211 determines that the selection instruction is not received from the personal computer 1 and the button switch 24 (step S101; NO), the process proceeds to step S103.

Then, in step S103, the determination section 212 determines whether or not the personal computer 1 operates on Windows (registered trademark). Windows (registered trademark) corresponds an example of the “first operating system.” If the determination section 212 determines that the personal computer 1 operates on Windows (registered trademark) (step S103; YES), the process proceeds to step S117. If the determination section 212 determines that the personal computer 1 does not operate on Windows (registered trademark) (step S103; NO), the process proceeds to step S105. In step S105, the determination section 212 determines whether or not the printer 5 is a dedicated printer. If the determination section 212 determines that the printer 5 is the “dedicated printer” (step S105; YES), the process proceeds to step S117. If the determination section 212 determines that the printer 5 is not the “dedicated printer” (step S105; NO), the process proceeds to step S107.

Then, in step S107, the determination section 212 determines whether the data JC for the first device 3 has been received from the personal computer 1. The first device 3 includes a change machine. If the determination section 212 determines that the data JC for the first device 3 has been received from the personal computer 1 (step S107; YES), the process proceeds to step S117. If the determination section 212 determines that data JC for the first device 3 was not received from the personal computer 1 (step S107; NO), the process proceeds to step S109. Then, in step S109, the setting section 213 selects the first control CT1 or the second control CT2 based on the data JC received from the personal computer 1 and the table TBL stored in the setting memory section 216. The table TBL has the first control CT1 or the second control CT2 in association with the data JC received from personal computer 1. Then, the process proceeds to step S113.

If YES in step S101, then in step S111, the determination section 212 determines whether to select the first control CT1 or the second control CT2 in response to the selection instruction from the personal computer 1 or the button switch 24. For example, when the reception section 211 receives the first instruction information JC1 from the personal computer 1, the determination section 212 determines to select the first control CT1. For example, when the reception section 211 receives the second instruction information JC2 from the personal computer 1, the determination section 212 determines to select the second control CT2. Next, in step S113, the control section 21 determines whether the first control CT1 has been selected in step S109 or in step S111.

If the control section 21 determines that the first control CT1 has not been selected (step S113; NO), the process proceeds to step S115. Then, in step S115, the second control section 215 performs the second control CT2 on the data JC received from the personal computer 1. Thereafter, the process ends. If the control section 21 determines that the first control CT1 has been selected (step S113; YES), the process proceeds to step S117. If YES in step S103, if YES in step S105, if YES in step S107, or if YES in step S113, in step S117, the first control section 214 performs the following process. In other words, the first control section 214 performs the first control CT1 on the data JC received from the personal computer 1. Thereafter, the process ends.

As described above with reference to the drawings, the hub 2 according to the present embodiment is the hub 2 that relays communication between the personal computer 1 and the printer 5. The hub 2 has the control section 21. The control section 21 is configured to be capable of performing the first control CT1 that performs the first process TR1 on the data JC received from the personal computer 1 and that transmits the data obtained by the first process TR1 to the printer 5, and the second control CT2 that, without performing the first process TR1 on the data JC received from the personal computer 1, transmits the data JC to the printer 5, and the control section 21 performs either the first control CT1 or the second control CT2.

According to this configuration, the user can use a printer 5 corresponding to the first control CT1 (for example, a dedicated printer) and a printer 5 corresponding to the second control CT2 (for example, a printer that is not a dedicated printer) by connecting them to the hub 2. Therefore, user convenience can be improved.

The hub 2 according to the present embodiment is equipped with the setting memory section 216 that, in response to the data JC received from personal computer 1, sets either the first control CT1 or the second control CT2, and the control section 21 performs either the first control CT1 or the second control CT2 based on the setting of the setting memory section 216.

According to this configuration, either the first control CT1 or the second control CT2 is performed based on the setting of the setting memory section 216. Therefore, by appropriately setting the setting memory section 216, either the first control CT1 or the second control CT2 can be performed appropriately. Therefore, user convenience can be improved.

The hub 2 according to the present embodiment is equipped with the button switch 24 that selects either the first control CT1 or the second control CT2 according to an operation by the user, and the control section 21 performs either the first control CT1 or the second control CT2 based on a selection result of the button switch 24.

According to this configuration, the user can select either the first control CT1 or the second control CT2 by operating the button switch 24. By this, user convenience can be improved.

In the hub 2 according to the present embodiment, the control section 21 performs the first control CT1 when the personal computer 1 operates on Windows (registered trademark), and performs the second control CT2 when the personal computer 1 operates on Mac OS (registered trademark).

According to this configuration, either the first control CT1 or the second control CT2 can be performed in accordance with the OS of the personal computer 1. By this, either the first control CT1 or the second control CT2 can be appropriately performed. Therefore, user convenience can be improved.

In the hub 2 according to the present embodiment, the data JC includes command data JCM corresponding to a command CM that instructs the printer 5 to perform the process, and the first process TR1 includes converting the command data JCM into the command CM.

According to this configuration, the first process TR1 includes the conversion of the command data JCM into the command CM, so the data JC in the XML format or the text format can be used as the command data JCM. Therefore, it is possible to simplify the process instruction from the personal computer 1 to the printer 5.

When the first device 3 including the change machine is communicably connected to the hub 2 of the present embodiment and the hub 2 communicates with the first device 3, the control section 21 performs the first control CT1.

According to this configuration, when communicating with the first device 3 including the change machine, the control section 21 performs the first control CT1. By this, a communication log can be left in the hub 2, for example. Therefore, it is possible to reliably leave records of the transfer of money.

The communication control method for the hub 2 according to the present embodiment is a communication control method for the hub 2 that relays communication between the personal computer 1 and the printer 5. The communication control method is being configured to perform the first control CT1 that performs the first process TR1 on the data JC received from the personal computer 1 and transmits the data JC obtained by the first process TR1 to the printer 5, and second control CT2 that does not perform the first process TR1 on the data JC received from the personal computer 1 and transmits the data JC to the printer 5, and the communication control method performs either the first control CT1 or the second control CT2. According to this configuration, the communication control method for the hub 2 according to the present embodiment achieves the same operations and effects as the hub 2 according to the present embodiment.

The communication control system 100 according to the present embodiment includes the personal computer 1, the printer 5, and the hub 2 that relays communication between the personal computer 1 and the printer 5. The hub 2 has the control section 21. The control section 21 is configured to be able to perform the first control CT1 that performs the first process TR1 on the data JC received from the personal computer 1 and transmits the data obtained by the first process TR1 to the printer 5, and the second control CT2 that does not perform the first process TR1 on the data JC received from the personal computer 1 and transmits the data JC to the printer 5, and performs either the first control CT1 or the second control CT2. According to this configuration, the communication control system 100 according to the present embodiment achieves the same operations and effects as the hub 2 according to the present embodiment.

Note that the present embodiment described above is merely one aspect of the present disclosure, and can be arbitrarily modified and applied within the scope of the present disclosure.

In the present embodiment, a case where the “information process device” is a personal computer 1 will be described, but the embodiment is not limited to this. The “information process device” may be, for example, a tablet terminal or a smartphone. The “information process device” may also be, for example, a server device. When the “information process device” is a server device, for example, Windows (registered trademark) or UNIX (registered trademark) is installed in the server device as an OS.

In the present embodiment, a case where the “first operating system” is Windows (registered trademark) and the “second operating system” is Mac OS (registered trademark) will be described, but the embodiment is not limited to this. When the “information process device” is a smartphone, for example, the “first operating system” may be Android (registered trademark) and the “second operating system” may be iOS (registered trademark).

In this embodiment, a case where the personal computer 1 is connected to the fourth communication interface 224 will be described, but the embodiment is not limited to this. The personal computer 1 may be connected to any one of the first communication interface 221, the second communication interface 222, or the third communication interface 223.

In the present embodiment, a case where the “printing device” is the printer 5 will be described, but the embodiment is not limited to this. The “printing device” only need to have a printing function. The “printing device” may be, for example, a copier. The “printing device” may also be a multifunction peripheral (MFP).

In the present embodiment, a case where printer 5 is a thermal printer will be described, but the embodiment is not limited to this. The printer 5 may be, for example, an inkjet printer.

In the present embodiment, a communication control method that is realized by the processor 21A provided in the hub 2 by performing the control program PG is described. However, it is also possible to configure the control program PG that is performed by the processor 21A to realize this communication control method in the form of a recording medium readable by a computer or a transmission medium that can transmit this control program PG. The above recording medium may be a magnetic or optical recording medium, or a semiconductor memory device. Examples of the recording medium include a portable or fixed recording medium such as a flexible disk, an HDD, a compact disk read only memory (CD-ROM), a digital versatile disk (DVD), a Blu-ray (registered trademark) Disc, a magneto-optical disk, a flash memory, and a card-type recording medium. The recording medium may be a nonvolatile storage device such as a RAM or a ROM, which is an internal storage device included in the hub 2.

In the present embodiment, the processor 21A performs the control program PG to control each component of the hub 2, but this disclosure is not limited to this. The control section 21 may be equipped with, for example, an application specific integrated circuit (ASIC), and the ASIC may perform the process by the implemented functions. The control section 21 may be equipped with, for example, a signal processing circuit, and the signal processing circuit may perform signal processing to perform its process.

The process units of the flowchart shown in FIG. 3 are divided according to the main process content in order to facilitate understanding of the process of the control section 21, and the present disclosure is not limited by the way in which the process units are divided or by their names. The process of the control section 21 may be further divided into many process units depending on the process content. In addition, it may be divided so that a single process unit includes more processes.

Each of the functional sections shown in FIG. 2 shows a functional configuration, and a specific mounting form is not particularly limited. In other words, it is not always necessary to mount hardware individually corresponding to each functional section, and it is also possible to adopt a configuration in which one processor performs a program to realize the functions of a plurality of functional sections. In each of the above-described embodiments, a part of the functions realized by software may be realized by hardware, or a part of the functions realized by hardware may be realized by software. Specific detailed configurations of other parts of the hub 2 can be arbitrarily changed without departing from the scope of the present disclosure.

What is claimed is:

1. A relay device that relays communication between an information process device and a printing device, the relay device comprising:
a control section, wherein
the control section
is configured to perform a first control that performs a first process on data received from the information process device and that transmits data obtained by the first process to the printing device and a second control that, without performing the first process on data that was received from the information process device, transmits the data to the printing device and
performs either the first control or the second control.

2. The relay device according to claim 1, further comprising:
a setting memory device that sets either the first control or the second control based on the data received from the information process device, wherein
the control section performs either the first control or the second control based on a setting of the setting memory device.

3. The relay device according to claim 1, further comprising:
an operation receiving mechanism that selects either the first control or the second control in accordance with an operation by the user, wherein
the control section performs either the first control or the second control based on a selection result of the operation receiving mechanism.

4. The relay device according to claim 1, wherein
the control section
performs the first control when the information process device operates on a first operating system and
performs the second control when the information process device operates on a second operating system, which is different from the first operating system.

5. The relay device according to claim 1, wherein
the data includes command data corresponding to a command that instructs the printing device to perform a process and
the first process includes converting the command data into the command.

6. The relay device according to claim 5, wherein
a change machine is communicably connected and
when communicating with the change machine, the control section performs the first control.

7. A communication control method for a relay device that relays communication between an information process device and a printing device, the communication control method comprising:
performing a first control that performs a first process on data received from the information process device and transmits data obtained by the first process to the printing device, and a second control that transmits the data to the printing device without performing the first process on the data received from the information process device and performing either the first control or the second control.

8. A communication control system comprising:
an information process device;
a printing device; and
a relay device that relays communication between the information process device and the printing device, wherein
the relay device has a control section,
the control section
is configured to perform a first control that performs a first process on data received from the information process device and that transmits data obtained by the first process to the printing device and a second control that, without performing the first process on data that was received from the information process device, transmits the data to the printing device and
performs either the first control or the second control.
